(19) United States
(12) Patent Application Publication
(10) Pub. No.: US 2022/0401278 A1
(43) Pub. Date: Dec. 22, 2022

(54) Patient Turning Device

(71) Applicants: Jawad Kawaja, Sugar Land, TX (US); Tahmina Kawaja, Sugar Land, TX (US)

(72) Inventors: Jawad Kawaja, Sugar Land, TX (US); Tahmina Kawaja, Sugar Land, TX (US)

(21) Appl. No.: 17/495,007

(22) Filed: Oct. 6, 2021

Related U.S. Application Data
(60) Provisional application No. 63/212,883, filed on Jun. 21, 2021.

(51) Int. Cl. A61G 7/00

(52) U.S. Cl. CPC A61G 7/001

(57) ABSTRACT

The present invention relates to a patient rolling or turning device for healthcare assistants, such as caregivers and nurses. The device allows a singular healthcare assistant to smoothly and slowly laterally turn or rotate a bedridden patient. The device includes a foam-based frame having a flat base and three curved legs extending vertically from the flat base. The frame comprises two leg supports for receiving and supporting the patient's legs, and a plurality of handles that can be grasped by a nurse or caregiver to rotate the patient.

### CROSS-REFERENCE TO RELATED APPLICATION

The present application claims priority to, and the benefit of, U.S. Provisional Application No. 63/212,883, which was filed on Jun. 21, 2021, and is incorporated herein by reference in its entirety.

### FIELD OF THE INVENTION

The present invention relates generally to the field of nursing devices. More specifically, the present invention relates to a high-density foam-based patient turning tool that is used for laterally rolling over a bedridden patient in bed. The patient turning tool features two leg support areas in which a patient's legs can be placed, and includes multiple handles to allow a user to rotate the patient in a left or right direction. The patient turning tool can easily be used by users to clean bedridden patients during standard bathing or cleaning up unsanitary accidents, etc. The invention offers a unique way for hospitals, nursing homes, rehab facilities, hospital care locations, etc., to ensure that patients are comfortably rolled for various purposes. Accordingly, the present disclosure makes specific reference thereto. Nonetheless, it is to be appreciated that aspects of the present invention are also equally applicable to other like applications, devices and methods of manufacture.

### BACKGROUND

As is well known in the health care industry and by caregivers and nurses, many patients are completely or substantially bedridden due to their inability to move or due to the level of discomfort associated with moving on or off the bed. It is well known that health care assistants, which includes health care professionals such as doctors, nurses and caregivers, etc., are often required to move a bedridden patient in order to have access to the parts of his or her body that are lying on the bed, and to the bedding materials themselves. For example, various kinds of treatments for bedridden patients require the nurse or caregiver to roll over or turn the patients, while the patients are lying on the bed. Application of medication on a patient's back, cleaning of the patient's body during bathing, cleaning up of unsanitary accidents, etc., are a few examples of the situations in which the patient is often required to be turned.

It is very difficult for a singular health care assistant or caregiver to roll over a patient in a bed. The user must move the patient to the desired position, and then hold the patient in that position while attempting to simultaneously accomplish the desired health care task. Generally, two or more nurses or caregivers are required to provide support and turn the patient properly. However, involving two or more caregivers in turning the patient may impact their primary tasks. This may lead to inefficiency, as more than one nurse/caregiver has to be involved to assist a single patient. Further, bedridden patients who are overweight, cannot be held by a singular person/nurse/caregiver and may require two or more people, depending upon the weight of the patient. It may also be difficult for the additional nurse/caregiver to be available for assisting in turning over the patient.

Additionally, in the event that the bedridden patient has had an accident, trying to roll the patient without exacerbating the mess can be difficult. Also, while bathing bedridden patients, the nurses/caregivers may have a difficult time in cleaning the back area of the patient's body. Thus, an easier way to turn a bedridden patient is required. The nurses/caregivers often grasp the bedridden patients by their clothes while turning them over on the bed. However, if the grip between the clothes and the caregiver's hands is not properly formed, then the patient may become quite uncomfortable.

Therefore, there exists a long felt need in the art for a patient turning device that can be easily used by nurses, caregivers and other individuals, in order to help them in turning bedridden patients. There is also a long felt need in the art for a patient turning tool that offers a unique way of ensuring that patients remain comfortable while rolling them over on a bed. Additionally, there is a long felt need in the art for a patient turning device that eliminates the need to involve two or more nurses, caregivers, etc., when turning bedridden patients. Moreover, there is a long felt need in the art for a patient turning device that enables nurses and caregivers to work on separate tasks, thereby ensuring that they remain efficient. Further, there is a long felt need in the art for a patient turning tool that makes it easy to turn overweight and elderly patients. Furthermore, there is a long felt need in the art for a patient turning device that can be used to turn bedridden patients for cleaning, medication, etc. Finally, there is a long felt need in the art for a patient turning device that ensures that patients remain comfortable while turning them over in bed.

The subject matter disclosed and claimed herein, in one embodiment thereof, comprises a patient rolling device. The patient rolling device supports the legs of a bedridden patient, and helps in turning or rolling the patient laterally. The patient rolling device is a W-shaped frame, made of a soft material such as foam. The frame has a flat base, allowing the device to be placed on a flat surface. The device further comprises a pair of side legs that extend vertically from the flat base, and a middle leg extending vertically from the flat base. One of the pair of side legs and middle leg form a first U-shaped leg supporting slot, and the second of the pair of the side legs and the middle leg form a second U-shaped leg supporting slot. Each slot receives and supports a leg of the patient, and a handle on each of the side legs and top of the middle leg is grasped by a caregiver to rotate the patient gently and smoothly from one position to the next.

In this manner, the novel patient rolling or turning device of the present invention accomplishes all of the forgoing objectives, and provides a relatively safe, easy and convenient solution to turning a bedridden patient. The device allows a singular caregiver to easily, slowly and smoothly turn, rotate or otherwise move a patient into a desired position for accomplishing desired tasks, such as changing bandages, clothes or bedding, etc.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a patient rolling device. The patient rolling device is designed to support the legs of a patient and to turn or roll the patient laterally. The patient rolling device comprises a W-shaped frame made of a soft material such as foam. The frame comprises a flat base, thereby allowing the device to be placed on a flat surface. The frame also comprises a pair of side legs, extending vertically from the flat base, and a middle leg extending vertically from the flat base. Further, one of the pair of side legs and the middle leg form a first U-shaped leg supporting slot, and the second of the pair of the side legs and the middle leg form a second U-shaped leg supporting slot. Each slot receives and supports a leg of the patient and a handle on each of the side legs, and the top of the middle leg is grasped by a caregiver to gently and smoothly rotate the patient from one position to the next.

In yet another embodiment of the present invention, the first position is a supine position, and the second position can be one of the left or right lateral recumbent position. In yet another embodiment of the present invention, the pair of side legs have handles on their outer edges, and the middle leg has a handle on the top edge. In yet another embodiment, the device can be an inflated device in which the handles are detachably-secured to the legs.

In yet another embodiment of the present invention, a bedridden patient turning tool is disclosed. The tool includes two leg supporting slots, a flat base and three curved legs, extending vertically from the flat base. Each curved leg has a handle for holding the tool, and the tool allows a user to turn a patient whose legs are inserted in said leg supporting slots.

In yet another embodiment of the present invention, a patient rolling device for turning a patient from a supine to a lateral recumbent position is disclosed. The patient rolling device allows a caregiver to turn a patient without utilizing another person and with minimal effort. The device includes two leg supports. Each leg support is defined by concave edges, and is configured to receive and support a leg of a patient, and a plurality of handles for a user to grasp the device and rotate the device slowly and gently to rotate or laterally roll the patient into a lateral recumbent position.

In yet another embodiment of the present invention, a method for laterally turning or rolling a patient by a caregiver or a nurse is described. The method includes initially providing a patient turning device to a caregiver, then lifting both legs of a bedridden patient when the patient is in a supine position to place the device directly under the legs of the patient. Thereafter, placing the patient turning device under the lifted legs of the bedridden patient, such that the device is directly below the legs of the patient, then placing both the legs of the patient in the leg-supporting slots of the device. Next, holding one or more handles positioned on the device and rotating the device in a desired direction to laterally turn the patient to the desired position. The method is useful for smoothly and gently turning a patient sideways with little effort.

The advantage of the patient turning/rolling device of the present invention is that it allows caregivers to independently roll over a patient, and is especially useful for overweight patients, elderly patients, etc. The device enables caregivers to easily clean a patient's backside for standard bathing, cleaning up unsanitary accidents, etc. The device offers a way for hospitals, nursing homes, rehab facilities, hospice care locations, etc., to rotate their patients and keep them comfortable.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the patient rolling device of the present invention in accordance with the disclosed architecture;

FIG. 2 illustrates a perspective view of how one potential embodiment of the patient turning device of the present invention may be positioned under a bedridden patient in accordance with the disclosed architecture;

FIG. 3 illustrates a perspective view showing a caregiver turning a bedridden patient using one potential embodiment of the patient turning device of the present invention in accordance with the disclosed architecture; and

FIG. 4 illustrates a flow diagram showing the steps performed by a caregiver when turning a bedridden patient using one potential embodiment of the patient turning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a patient turning device that can be easily used by nurses, caregivers and other individuals in order to help them in turning bedridden patients. There is also a long felt need in the art for a patient turning tool that offers a unique way of ensuring that patients remain comfortable while rolling them over on the bed. Additionally, there is a long felt need in the art for a patient turning device that eliminates the need to involve two or more nurses, caregivers, etc., when turning bedridden patients. Moreover, there is a long felt need in the art for a patient turning device that enables nurses and caregivers to work on separate tasks and ensures they remain efficient. Further, there is a long felt need in the art for a patient turning tool that makes it easy to turn overweight and elderly patients. Furthermore, there is a long felt need in the art for a patient turning device that can be used to turn bedridden patients for cleaning, medication, etc. Finally, there is a long felt need in the art for a patient turning device that ensures that patients remain comfortable while turning them over on the bed.

The present invention, in one exemplary embodiment, is a novel bedridden patient turning tool. The tool includes two leg supporting slots, a flat base and three curved legs extending vertically from the flat base. Each curved leg has a handle for holding the tool, and the tool allows a user to turn a patient whose legs are inserted in said leg supporting slots.

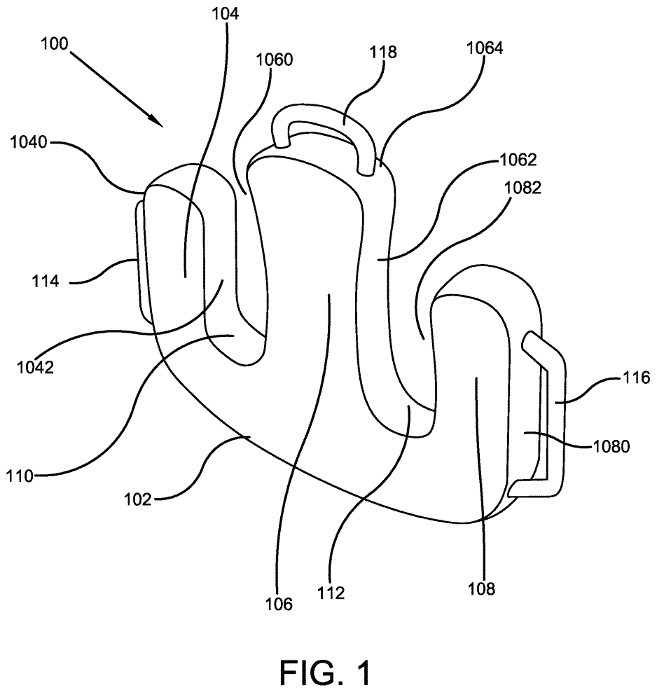

Referring initially to the drawings, FIG. 1 illustrates a perspective view of a patient rolling device of the present invention. The patient rolling device 100 of the present invention is designed to help nurses and caregivers in rolling over a bedridden or immobile patient in bed or on any planar surface. The device 100 aids a user in laterally rolling a bedridden patient, such that use of the device allows a singular person, such as a nurse or caregiver, to easily roll a bedridden patient without utilizing an extreme amount of force, and without causing any discomfort to the patient. The device 100 eliminates the need to lift the shoulders, hips or torso of a bedridden patient, and can be used with most any bedridden patient. More specifically, the patient rolling device 100 is a W-shaped, one-piece structure of hard foam. However, the device 100 can be of any suitable shape as is known in the art, as long as a patient's legs can be supported within. Further, the device 100 is typically comprised of hard foam or other absorbent material, but can be comprised of any suitable material as is known in the art. The device 100 comprises a flat base 102, which allows the device 100 to stably rest on a flat surface. Further, the device 100 comprises three legs: a first side leg 104, a middle leg 106, and a second side leg 108, which extend vertically upwards from the flat base 102, such that a first U-shaped leg support slot 110 is formed between the first side leg 104 and the middle leg 106 and a second U-shaped leg support slot 112 is formed between the middle leg 106 and the second side leg 108. In the present embodiment, the length of the first side leg 104 and the second side leg 108 are equal, and the length of the middle leg 106 is longer than the length of both the first side leg 104 and the second side leg 108. However, the side legs 104, 108 and the middle leg 106 can be of any suitable length as is known in the art based on a user's wants and/or needs.

The first side leg 104 has a curved outer edge 1040 that comprises a first handle 114. The first handle 114 can be manufactured of heavy-duty plastic or any other suitable material, and is slotted into the first side leg 104, or secured with any other suitable fasteners as are known in the art. The curved inner edge 1042 is concave in shape, and forms the first U-shaped leg support slot 110, along with the concave-shaped first edge 1060 of the middle leg 106. Similarly, the second side leg 108 has a curved outer edge 1080 that comprises a second handle 116. The second handle 116 is also manufactured of heavy-duty plastic, or any other suitable material, and is slotted into the second side leg 108, or secured with any other suitable fasteners as are known in the art. The curved inner edge 1082 is concave in shape, and forms the second U-shaped leg support slot 112 along with the concave shaped second edge 1062 of the middle leg 106. Further, the top end 1064 of the middle leg 106 comprises a third handle 118 manufactured of heavy-duty plastic, or any other suitable material and is slotted into the middle leg 106, or secured with any other suitable fasteners as are known in the art. The first handle 114, the second handle 116 and the third handle 118 are used by a nurse or caregiver for holding the device 100 during use, and for turning or rolling a patient from a first position, such as a supine position, to a second position such as a left or right lateral recumbent position.

The first U-shaped leg slot 110 and the second U-shaped leg slot 112 are sized and configured to receive a first leg and a second leg of a patient while the patient is lying on a bed. The legs of the patient are supported by the inner edges of the first side leg 104, the middle leg 106 and the second side leg 108 and also by the flat base 102. The slots 110, 112 are wide enough to support the thighs of a bedridden patient. Once the legs are placed securely within the slots, the device 100 is turned sideways by a nurse or a caregiver, using one or more of the first handle 114, the second handle 116 and the third handle 118 which turns the patient sideways. The device 100 is especially useful for cleaning and sanitizing the back area of the patient to prevent the patient from obtaining bedsores.

The patient turning device 100 allows hospitals, nursing homes, rehab facilities, hospice care locations, etc., and any other suitable healthcare facility as is known in the art, to rotate their patients and keep them comfortable. The foam, silicon or rubber material or any other suitable material as is known in the art of the device 100 provides comfort to the patient, and can be held between the legs of the patient during the duration of a complete bathing, cleaning and dressing. The device 100 is also useful for turning sleeping patients, without disturbing their sleep. The patient rolling device 100 is useful for turning paralyzed stroke victims, spinal cord injury patients and elderly patients who are in the latter stages of dementia or Alzheimer's disease, etc., or any other suitable bedridden patient as is known in the art.

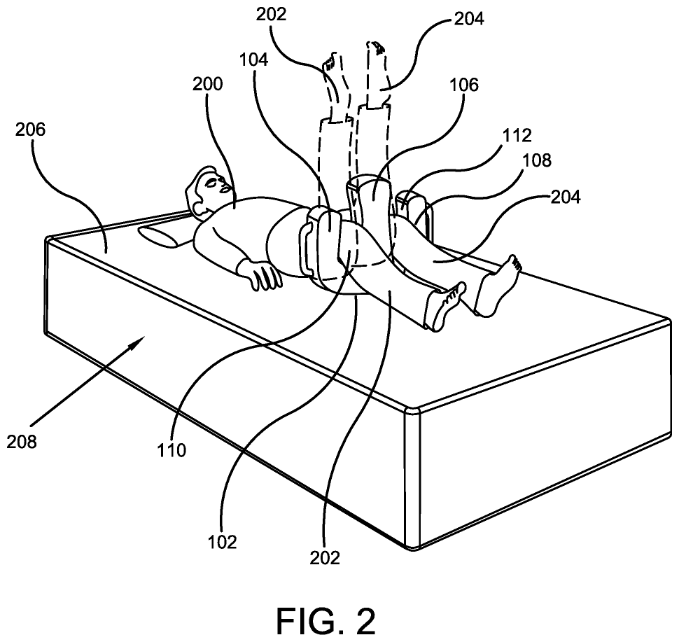

FIG. 2 illustrates a perspective view showing how the patient turning device of the present invention is positioned under a bedridden patient. In use, when turning or rolling a bedridden patient 200 on the surface 206 of a bed 208, the patient turning device 100 is placed below or underneath the legs 202, 204 of the patient 200. When placing the device 100, the legs 202, 204 of the patient 200 are raised/lifted upwards in an inclined or vertical position shown as 202′, 204′. As shown in FIG. 2, the patient 200 is in supine position, and the legs are raised to an elevated position 202′, 204′ for placing the device 100. Then, the patient turning device 100 is positioned on its flat base 102 on the surface 206, and in a position such that the first U-shaped leg support slot 110 is directly below or underneath the first leg, and the second U-shaped leg support slot 112 is directly below or underneath the second leg of the patient 200. When the turning device 100 is stably placed in the desired orientation, the first leg 202 is secured and placed in the first U-shaped leg support slot 110, and the second leg 204 is secured and placed in the second U-shaped leg support slot 112. The middle leg 106 separates the legs 202, 204, and also provides comfort to the bladder of the patient 200.

It should be appreciated that the legs 202, 204 of the patient 200 need only be lifted to a minimum of 30 degrees, such that the device 100 can be easily placed under the legs of the patient 200. The upper body, including the torso, shoulder and arms of the patient, are not touched when preparing the patient 200 for turning or rolling. The device 100 raises the center of gravity of a lying patient 200, and thus eases the turning or rolling of the patient using the device 100. Further, as stated supra, the handles are used for providing the necessary grip and force to roll the patient securely and easily from a supine or prone position to a left or right lateral recumbent position and back.

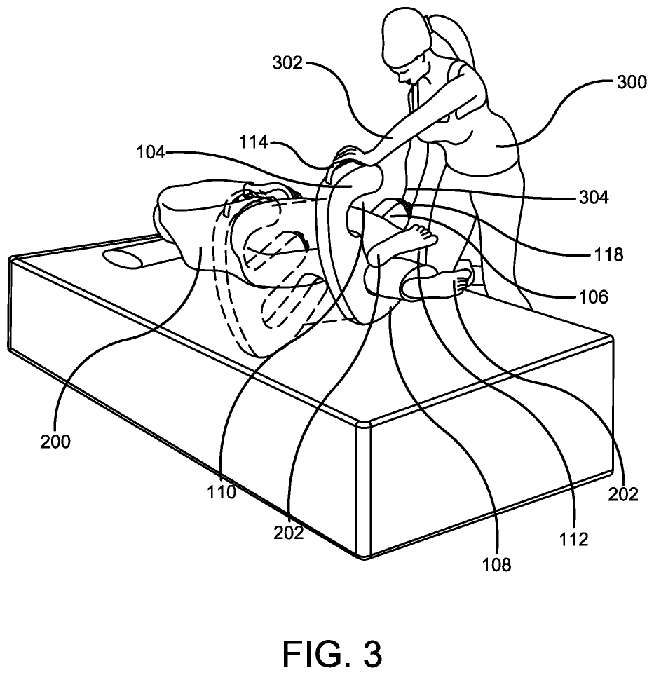

FIG. 3 illustrates a perspective view showing a caregiver turning the bedridden patient, using the patient turning device of the present invention. In the present embodiment, a caregiver 300 turns the patient 200 from the supine position as shown in FIG. 2, to a left recumbent position as shown by holding the patient turning device 100 using the first handle 114 positioned on the first side leg 104 by a user's first hand 302, and the third handle 118 is disposed on top of the middle leg 106 by a second hand 304. The device 100 provides adequate support to the lower body of the patient by retaining the first leg 202 in the first U-shaped leg support slot 110, and retaining the second leg 204 in the second U-shaped leg support slot 112. Once the process of turning the patient is complete, the device 100 can be easily removed by pulling the device 100 from the bottom of the legs 202, 204 of the patient 200. The removed position of the device 100 is shown through the dashed lines in FIG. 3.

It should be appreciated that using the patient rolling device 100 of the present invention, the nurse or caregiver 300 grasps the handles and rotates the tool/device 100 left or right to easily move the patient's position. The patient 200 avoids bed sores and caregivers can have easy access for standard cleansing, cleaning up unsanitary messes, etc. Only a singular caregiver 300 is needed to gently and comfortably rotate the patient 200 using the device 100.

In the preferred embodiment, the foam material of the patient turning device 100 is a generally absorbent material, and has a layer of substantially impermeable material, such as nylon, so that any fluids, including bodily fluids and medicines, are prevented from soaking or otherwise passing through to the interior of the device 100. In one embodiment, the device 100 can have a layer of anti-microbial material for providing additional protection to the caregiver and nurses.

In an alternative embodiment of the present invention, the first handle 114, the second handle 116 and the third handle 118 are detachable, and the device 100 is inflatable. This allows for a disposable version of the patient turning device, and provides for easy storage of the deflated device.

The turning or rolling of a bedridden patient using the turning device 100 is slow, smooth and very gentle, such that it does not cause any discomfort to the patient, even if the patient has serious injuries. The device 100 can be placed in-between the patient's legs for hours, without any discomfort to the patient. A caregiver or nurse can easily rotate even obese patients without hurting their back and shoulders, which can lead to pain and long-term medical problems.

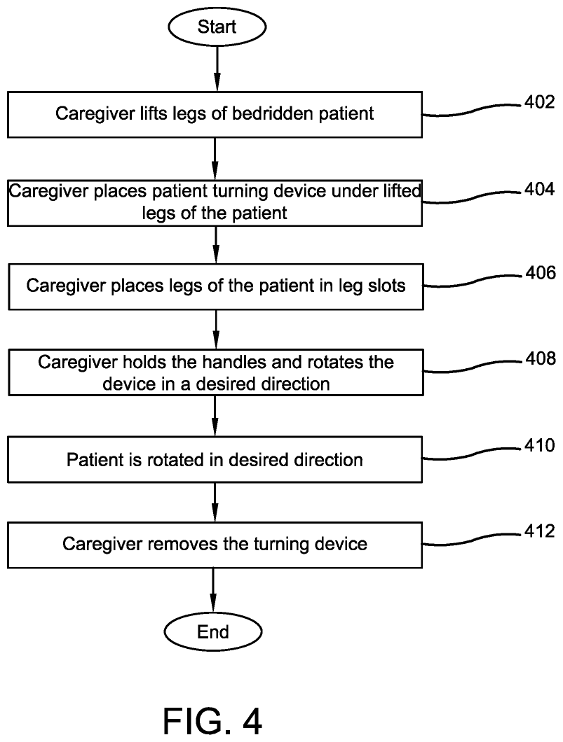

FIG. 4 illustrates a flow diagram showing the steps performed by a caregiver when turning a bedridden patient, using the patient turning device of the present invention. Initially at 402, when placing the patient turning device, a caregiver lifts both legs of a bedridden patient when the patient is in a supine position. Then at 404, the caregiver places the bedridden patient turning device underneath the elevated legs of the bedridden patient, such that the device is directly below the legs of the patient. Thereafter at 406, the caregiver places both the legs of the patient in the leg slots of the device. Then at 408, the caregiver grasps one or more handles of the device and rotates the device in a desired direction. At 410, as a result of rotation of the device, the patient is rotated in a desired position as required by the caregiver, such as for providing bathing or any medication to the patient. Once the rotation is performed, at 412 the caregiver can remove the device from the legs of the patient.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “patient turning device”, “patient rolling device”, “turning device”, “rolling device”, and “device”, are interchangeable and refer to the patient turning device 100 of the present invention.

Notwithstanding the forgoing, the patient turning device 100 of the present invention can be of any suitable size and configuration as is known in the art without affecting the overall concept of the invention, provided that it accomplishes the above-stated objectives. One of ordinary skill in the art will appreciate that the size, configuration, and material of the patient turning device 100 as shown in FIGS. 1-4 is for illustrative purposes only, and that many other sizes and shapes of the patient turning device 100 are well within the scope of the present disclosure. Although the dimensions of the patient turning device 100 are important design parameters for user convenience, the patient turning device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A patient rolling device that aids a user in rolling over a patient in a bed, the patient rolling device comprising:
a flat base which allows the patient rolling device to stably rest on a flat surface;
a first side leg;
a second side leg;
a middle leg, wherein the first side leg, the second side leg, and the middle leg extend vertically upwards from the flat base;
a first U-shaped leg support slot formed between the first side leg and the middle leg;
a second U-shaped leg support slot formed between the second side leg and the middle leg; and
at least one handle disposed along the first side leg, the second side leg, or the middle leg to allow a user to grasp when rolling a patient lying on a bed, wherein the first U-shaped leg support slot and the second U-shaped leg support slot receive a first leg and a second leg of a patient while the patient is lying on the bed, and further wherein the patient rolling device raises a center of gravity of the patient lying on the bed and allows a singular user to laterally roll the patient from a first position to a second position.

2. The patient rolling device of claim 1, wherein the patient rolling device is a W-shaped, one-piece structure comprised of a hard foam.

3. The patient rolling device of claim 1, wherein the first side leg and the second side leg are equal in length, and the middle leg is longer in length than the first side leg and the second side leg.

4. The patient rolling device of claim 1, wherein the first side leg has a curved outer edge that comprises a first handle.

5. The patient rolling device of claim 4, wherein the second side leg has a curved outer edge that comprises a second handle.

6. The patient rolling device of claim 5, wherein a top end of the middle leg comprises a third handle.

7. The patient rolling device of claim 6, wherein the first handle, the second handle and the third handle are detachable and the patient rolling device is inflatable.

8. The patient rolling device of claim 6, wherein the first side leg comprises a curved inner edge which is concave in shape and forms the first U-shaped leg support slot along with a concave shaped first edge of the middle leg for receiving a first leg of the patient.

9. The patient rolling device of claim 8, wherein the second side leg comprises a curved inner edge which is concave in shape and forms the second U-shaped leg support slot along with a concave shaped second edge of the middle leg for receiving a second leg of the patient.

10. The patient rolling device of claim 1, wherein a first position is a supine position and the second position is a left or right lateral recumbent position.

11. The patient rolling device of claim 1, wherein the patient rolling device is manufactured of a foam, a silicon or a rubber material.

12. The patient rolling device of claim 11 further comprising a layer of substantially impermeable material and an interior.

13. A patient rolling device for rolling over a bedridden or immobile patient in a bed, the patient rolling device comprising:
a flat base which allows the patient rolling device to stably rest on a flat surface;
a first side leg with a curved outer edge that comprises a first handle;
a second side leg with a curved outer edge that comprises a second handle;
a middle leg with a top end that comprises a third handle, wherein the first side leg, the second side leg, and the middle leg extend vertically upwards from the flat base;
a first U-shaped leg support slot, wherein the first side leg comprises a curved inner edge which is concave in shape and forms the first U-shaped leg support slot along with a concave shaped first edge of the middle leg for receiving a first leg of the patient;
a second U-shaped leg support slot, wherein the second side leg comprises a curved inner edge which is concave in shape and forms the second U-shaped leg support slot along with a concave shaped second edge of the middle leg for receiving a second leg of the patient;
wherein the first handle, the second handle, and/or the middle handle are grasped by a singular user when rolling the patient lying on the bed;
wherein the first U-shaped leg support slot and the second U-shaped leg support slot receive a first leg and a second leg of the patient while the patient is lying on the bed; and
further wherein the patient rolling device raises a center of gravity of the patient lying on the bed and allows the singular user to laterally roll the patient from a first position to a second position.

14. The patient rolling device of claim 13, wherein the first position is a supine position and the second position is a left or right lateral recumbent position.

15. The patient rolling device of claim 13, wherein the patient rolling device is manufactured of a foam, a silicon or a rubber material.

16. The patient rolling device of claim 13, wherein the patient rolling device is a W-shaped, one-piece structure comprised of a hard foam.

17. A method of turning a bedridden patient using a patient rolling device comprising the steps of:
elevating a pair of legs of the bedridden patient when the bedridden patient is in a supine position;
positioning the patient rolling device underneath the bedridden patient's pair of legs;
placing the bedridden patient's pair of legs in a pair of U-shaped leg support slots of the patient rolling device;
grasping one or more handles of the patient rolling device; and
rotating the patient rolling device in a desired direction to rotate the bedridden patient into a desired position.

18. The method of claim 17 further comprising a step of removing the patient rolling device from the bedridden patient's pair of legs after the step of rotating.

19. The method of claim 17 further comprising a step of leaving the patient rolling device between the bedridden patient's pair of legs after the step of rotating.

20. The method of claim 17, wherein the bedridden patient is rotated from a supine position to a left recumbent position by holding the patient rolling device via a user's first hand which grasps a first handle positioned on a first side leg and a user's second hand which grasps a second handle disposed on top of a middle leg.
